(19) United States
(12) Patent Application Publication
(10) Pub. No.: US 2010/0070092 A1
(43) Pub. Date: Mar. 18, 2010

(54) SYSTEM AND METHOD FOR CONTROLLING A ROOM ENVIRONMENT

(75) Inventors: Edward A. Winter, Oklahoma City, OK (US); Richard M. Bostian, Edmond, OK (US)

Correspondence Address: FOLEY & LARDNER LLP, 777 EAST WISCONSIN AVENUE, MILWAUKEE, WI, 53202-5306, US

(73) Assignee: Williams Furnace Company

(21) Appl. No.: 12/560,189

(22) Filed: Sep. 15, 2009

Related U.S. Application Data
(60) Provisional application No. 61/097,427, filed on Sep. 16, 2008.

(51) Int. Cl. G05B 15/00; F24F 7/007; F24F 11/053

(52) U.S. Cl. 700/278; 236/49.3; 236/44 C

(57) ABSTRACT

A system and method are provided for controlling a room environment including both the temperature and humidity of the air space within a room, regardless of the type and size of the terminal heat exchanger and regardless of variations in the temperature, flow rate, or other parameters of the cooling/heating medium supply received from the central heating and cooling supply system, and that improves the efficiency of operation of the terminal heat exchanger within the room, and the efficiency of operation of the central heating and cooling system supply for the facility.

### CROSS REFERENCE TO RELATED APPLICATION

The present Application claims the benefit of priority under 35 U.S.C. §119(e)(1) to U.S. Provisional Patent Application No. 61/097,427 titled “System and Method for Controlling a Room Environment” filed on Sep. 16, 2008, the disclosure of which is hereby incorporated by reference in its entirety.

### FIELD

The present invention relates to a system and method for controlling a room environment. The present invention relates more particularly to a system and method for controlling air temperature and humidity within the room by modulating an airflow through a terminal heat exchanger in the room, and modulating a flow of heating/cooling water through the terminal heat exchanger, where the heating/cooling water is received from a central heating and cooling system supply.

### BACKGROUND

This section is intended to provide a background or context to the invention recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

It is generally known to provide heating, ventilation and air-conditioning systems (HVAC) for use within a room, and for use within a plurality of rooms for a large facility (such as in hotels, offices, etc.), that receive a supply of a heating/cooling medium (e.g. water, glycol, or a combination thereof, etc.) from a central heating and cooling system supply. It is also generally known to provide a terminal heat exchanger as a local heat exchange device within the room to receive the heating/cooling water to effect a change in the temperature of the air within the room. It is also generally known to provide a control system and devices to operate the terminal heat exchanger to provide environmental control within the room(s). However, such known control systems and devices do not typically provide a desired amount of energy efficiency from the terminal heat exchanger, or from the central heating and cooling supply system, as is now desired by many facility owners. Further, such known control systems often do not adequately control both the humidity and the temperature within the room environment, which tends to lead to adverse consequences, such as permitting the growth of mold, mildew and the like due to high humidity, and the need to “over-cool” the environment to obtain a desired reduction in the humidity level within the room(s). For example, many of such known control systems and devices (e.g. thermostats, etc.) provide a simple on/off control scheme where heating and/or cooling is initiated or terminated based upon comparison of the air temperature within the room to a predetermined (or manually adjusted) setpoint. Also, many of such known control systems and devices do not adequately adapt to (or otherwise compensate for) changes in the cooling/heating water supply (e.g. temperature, flow rate, etc.) provided by the central heating and cooling system supply. Further, the terminal heat exchanger provided in the room(s) of many large facilities are typically sized to handle the “worst case” loading (from a heating and/or cooling perspective) expected for the seasonal and geographical location of the facilities, and do not operate as efficiently as desired during the majority of the time when conditions are not at a “worst case” scenario.

### SUMMARY

The present invention relates to a system and method for controlling a room environment including both the temperature and humidity of the air space within a room, regardless of the type and size of the terminal heat exchanger and regardless of variations in the temperature, flow rate, or other parameters of the cooling/heating medium supply received from the central heating and cooling supply system; and that improves the efficiency of operation of the terminal heat exchanger within the room, and the efficiency of operation of the central heating and cooling system supply for the facility.

### BRIEF DESCRIPTION OF THE DRAWINGS

Exemplary embodiments of the invention will hereafter be described with reference to the accompanying drawings, wherein like numerals denote like elements.

FIG. 1A is a schematic diagram of a heating and cooling system for controlling an environment in a room within a facility, according to an exemplary embodiment.

FIG. 1B is a detailed schematic diagram of an environmental control device and a terminal heat exchanger for system for controlling an environment in a room within a facility, according to an exemplary embodiment.

FIG. 2 is a schematic diagram of a terminal heat exchanger and related components for a heating and cooling system for controlling an environment in a room within a facility, according to an exemplary embodiment.

FIGS. 3A-3B are a schematic logic diagram of a system and method for controlling a room environment in a cooling/dehumidification mode within the facility of FIG. 1, according to an exemplary embodiment.

FIGS. 4A-4B are a schematic logic diagram of a system and method for controlling a room environment in a heating mode within the facility of FIG. 1, according to an exemplary embodiment.

FIG. 5 is the schematic logic diagram of the system and method for controlling a room environment in a cooling/dehumidification mode within the facility of FIGS. 3A-3B illustrated on a single page.

FIG. 6 is the schematic logic diagram of the system and method for controlling a room environment in a heating/dehumidification mode within the facility of FIGS. 4A-4B illustrated on a single page.

### DETAILED DESCRIPTION

Referring to the FIGURES, a system and method for controlling a room environment is shown according to an exemplary embodiment. The “room” is shown and described by way of example as a room in a facility having multiple rooms (such as a hotel, health care facility, office, school, condominium, or the like), where each room is shown to include an environment control device, such as a thermostat controller which controls the operation of a heat exchanger (referred to hereinafter as a ‘terminal’ heat exchanger to distinguish the heat exchanger from other types of systems having a ‘central’ type heat exchanger that is intended to service multiple rooms) such as a fan coil unit for providing a source of heating and cooling and airflow to the room, in response to signals received from the thermostat controller. The “environment” is generally considered to include the qualities of the air within the room, including among others the temperature and humidity of the air. The terminal heat exchanger is shown to receive a heating and cooling medium for transferring heat to, or from, the air in the room environment and/or condensing moisture from the air in the room environment (e.g., dehumidifying). However, according to other embodiments, the room may be any suitable enclosure within a facility, or may be the facility itself, and the thermostat controller may be any suitable type of control device having environmental parameter sensing capability and programmable control characteristics. Also, the terminal heat exchanger may be any suitable type of heat exchange device with any of a wide variety of coil configurations or other heat exchange surfaces and may have an air mover (e.g. fan, blower, etc.) that is integrated with, or located separately from, the heat exchanger. Further, the system is intended for use with any of a wide variety of central heating and cooling supplies (e.g. boilers, chillers, etc.) and the heating and cooling medium may be any suitable medium for circulation from a central supply to the terminal heat exchanger(s), such as water, glycol, etc. All of such potential variations are intended to be within the scope of this disclosure.

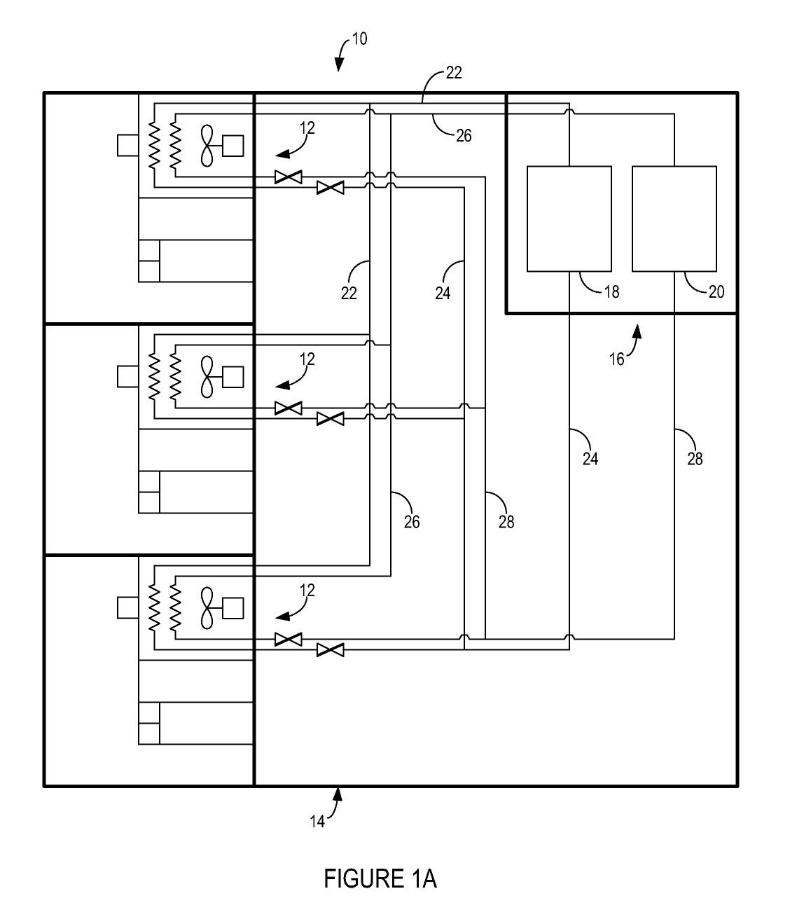

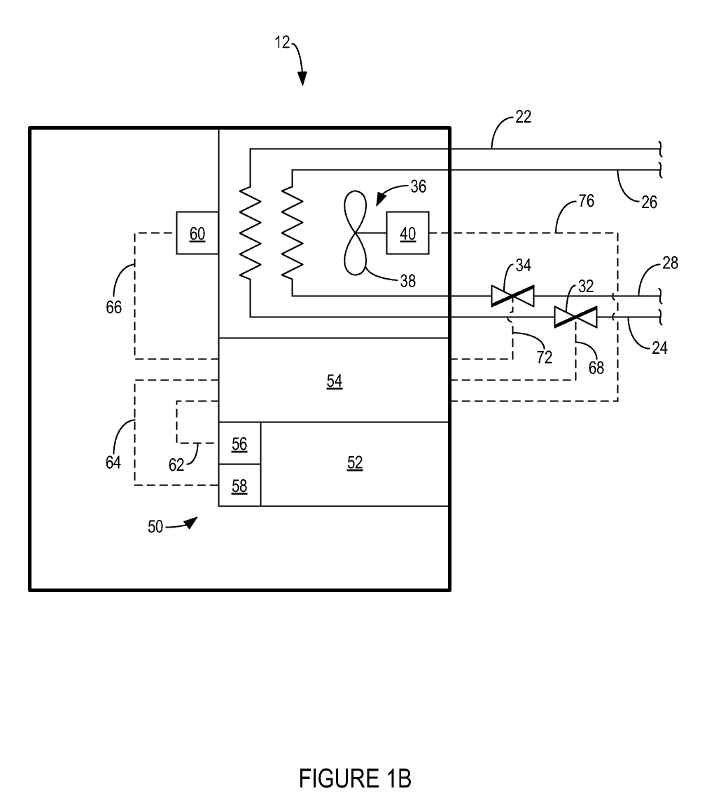

Referring to FIGS. 1A-1B, a system 10 for controlling a room environment is shown according to an exemplary embodiment. System 10 is shown for use with rooms 12 in a facility 14 (e.g. office, hotel, convention center, hospital, heath care facility, etc.), where the facility 14 includes a central heating and cooling supply 16 (shown by way of example to include a boiler 18, and a chiller 20, etc.) for circulating a heating medium and a cooling medium (e.g. water, glycol, etc.) through a heating water supply 22, a heating water return 24, a cooling water supply 26, and a cooling water return 28, to and from each of the rooms 12. Each room 12 includes a terminal heat exchange device 30 that receives the heating medium and the cooling medium from the facility's central heating and cooling supply 16 and operates to transfer heat from the heating medium to the air within the room 12 (in a heating mode of operation) and to transfer heat from the air within the room 12 to the cooling medium (in a cooling/dehumidification mode of operation). System 10 also includes an environmental control device shown as a thermostat controller 50 having a thermostat portion 52 with suitable sensors for monitoring the environmental parameters (e.g. temperature, humidity, etc.) of the air within the room 12 and which provides signals representative of such parameters to a controller portion 54 that receives the signals and executes a set of instructions according to preprogrammed (or manually programmed such as may be desirable to modify or update an existing control scheme) algorithms to provide output control signals to the terminal heat exchanger 30 to control the room environment by modulating the flow of the heating and/or cooling medium and the airflow through the terminal heat exchanger.

By modulating the heating medium and/or cooling medium and airflow through the terminal heat exchanger 30 in response to the temperature and humidity of the air within the room 12, system 10 is intended to control the room environment regardless of the specific type of heat exchanger used in the room, or the particular size and capacity of the central heating and cooling supply, or the particular type of heating/cooling medium used. Further, the system 10 is intended to enhance the efficiency of operation of the equipment used to control the room environment by intelligently monitoring the combination of temperature and humidity of the air within the room 12 to reduce the demand placed on the terminal heat exchanger 30, which in turn reduces the heating/cooling load on the facility's central heating and cooling supply 16.

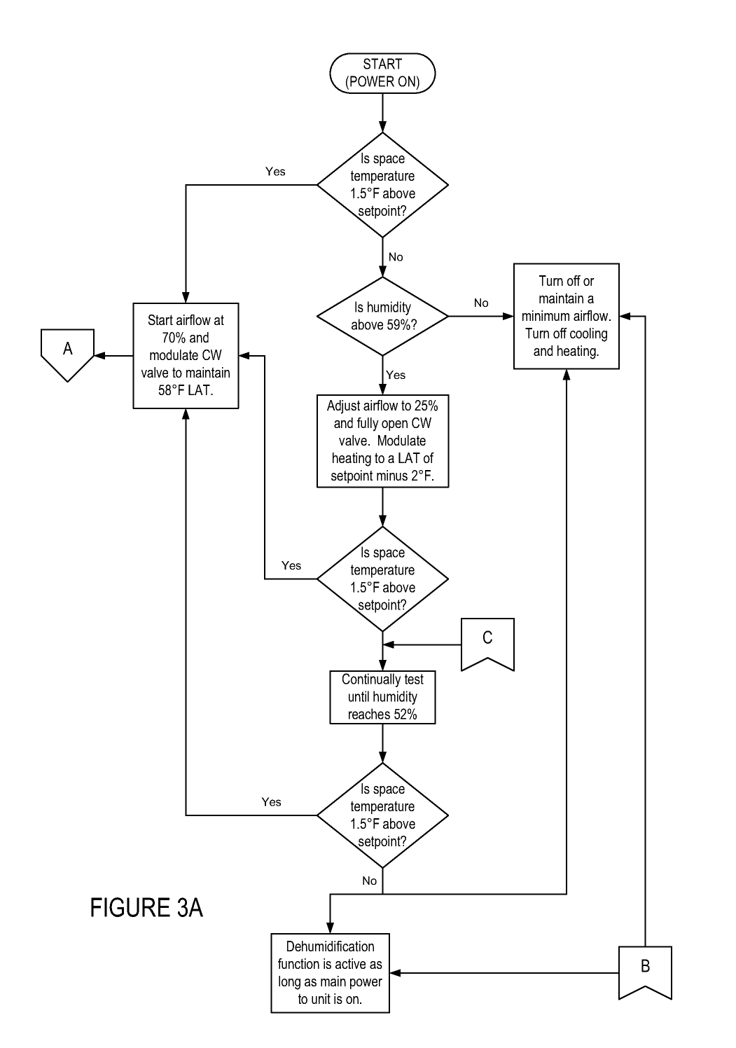

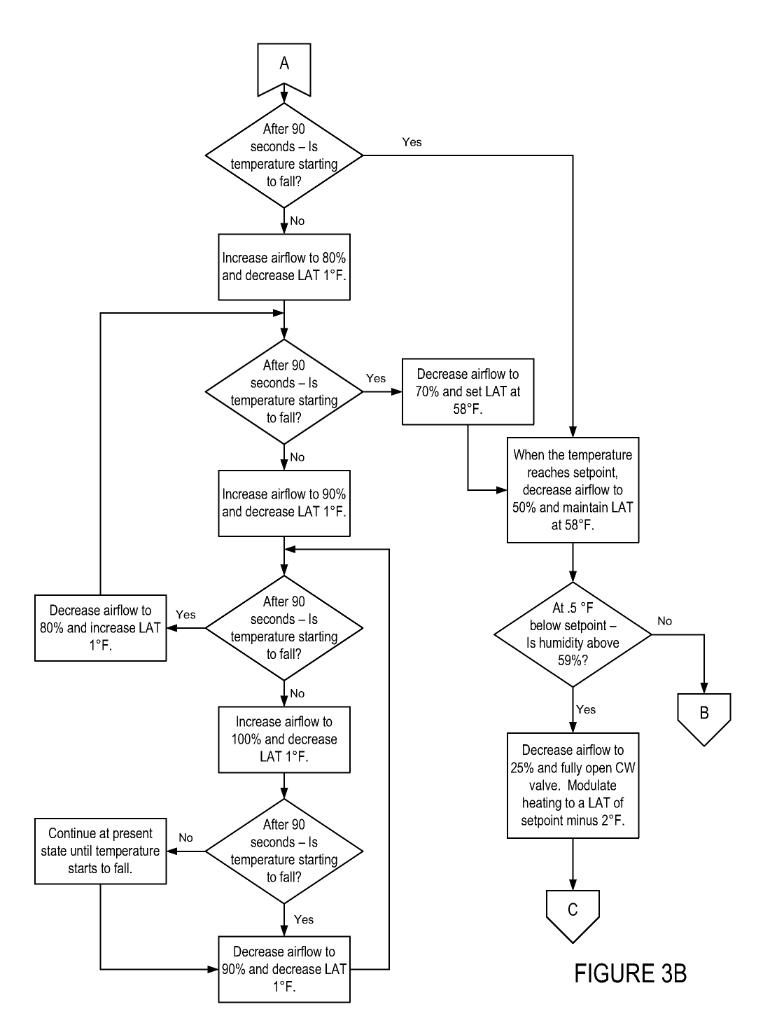

Referring further to FIGS. 1A-1B, the environmental control device 50 is shown to include a thermostat portion 52 that includes a temperature sensor 56 and a humidity sensor 58 that monitor the temperature and humidity of the air within the room 12, and a temperature sensor 60 that monitors the discharge temperature of the air discharged from (e.g. leaving, etc.) the terminal heat exchanger 30 (shown as ‘leaving air temperature’ (LAT) on FIGS. 3A-6)), and provide signals representative of the room air temperature 62 and humidity 64 and discharge air temperature 66 to the controller portion 54. The environmental control device 50 may be a custom designed device, or may be a commercially available programmable device, such as a direct digital control (DDC) type controller, for example, a 4×4 DDC (i.e. having four inputs and four outputs). The controller portion 54 receives the signals and executes a set of instructions according to a control method algorithm to be further described herein. The controller portion 54 provides output control signals to modulate flow of the heating and cooling medium and air flow through the terminal heat exchanger 30. According to the illustrated embodiment, the output control signals include a heating control signal 68 provided to a heating control device 32, and a cooling control signal 72 provided to a cooling control device 34, and an airflow control signal 76 provided to an airflow device 36.

According to one embodiment, the heating control device 32 and the cooling control device 34 are valves, such as a commercially available 0-10 VDC proportional, characterized ball valve, having a flow passage configured in a Y-type pattern. As the valve opens, the lower leg of the “Y” is presented and progresses until the top ends of the “Y” become presented when the valve is in the full-open position. The applicants believe that this flow passage configuration is particularly advantageous in this application to provide more precise control at low flow rate demands. This flow passage configuration is also advantageous in that it tends to provide a “self-cleaning” feature; if contaminants begin to accumulate within the passage and obstruct flow of the heating or cooling medium, the controller portion 54 continues to signal for increased flow and the valve will continue to open until sufficient flow/pressure clears the obstruction (e.g. dislodges, flushes, etc.). According to an alternative embodiment, the heating and cooling control devices may be modulating circulators, such as modulating circulators that are commercially available.

According to an alternative embodiment, the heating control device may be an electric heater that provides a source of heat for heating the room environment. For applications that use an electric heater in the terminal heat exchanger, a control device such as a silicon controlled rectifier (SCR) (such as a 0-10 VDC angle phased SCR) may be provided in the environmental control device (or other suitable location) to control operation of the electric heater.

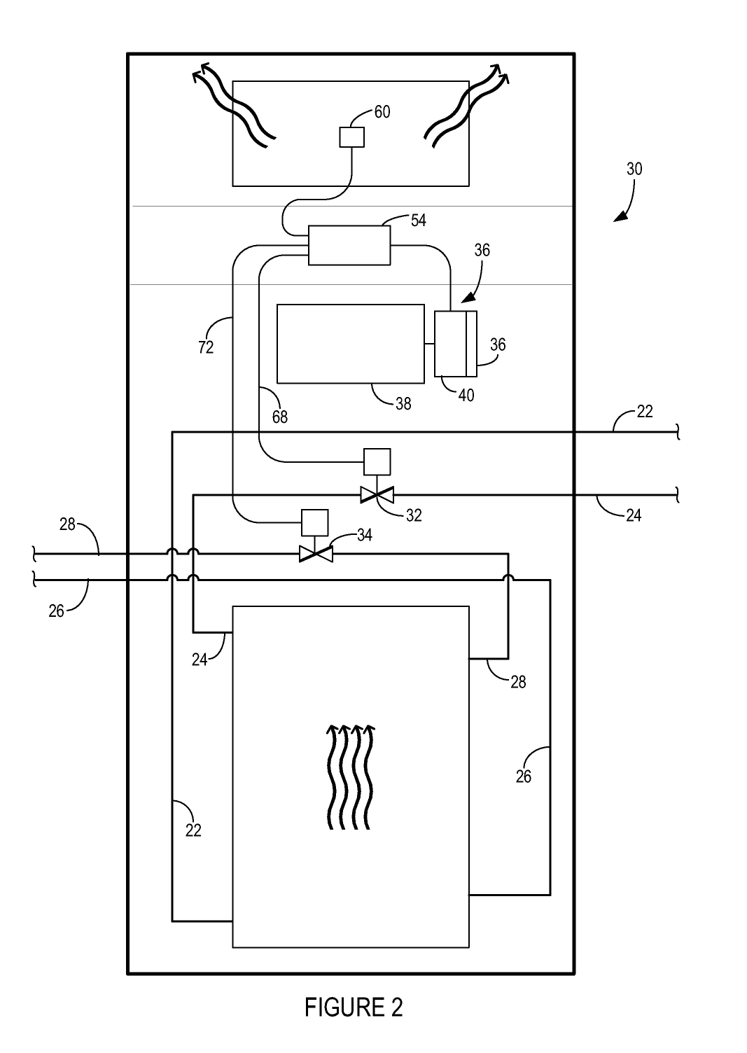

Referring further to FIGS. 1A-1B and 2, the airflow device 36 is shown according to one embodiment as a motor-driven fan 38 (e.g. blower, etc.) that directs a flow of air from the room 12 through the terminal heat exchanger 30 to enhance heat transfer in the terminal heat exchanger 30 and to provide air circulation within the room 12. The motor 40 may be any suitable motor that is capable of operating at variable speeds. According to one embodiment, the motor 40 is a brushless DC motor capable of efficient operation at a wide range of speeds, such as an electronically commutated motor (ECM). According to alternative embodiments, the motor may be another type of motor, such as a permanent split capacitor (PSC) single phase AC motor.

Referring further to FIGS. 1A-1B and 2, the terminal heat exchanger 30 is shown for example as a fan-coil type heat exchanger having separate solid heating and cooling coils for receiving the heating medium and the cooling medium respectively, such as a model ERB fan-coil unit commercially available from Williams Furnace Company of Colton, California. According to one embodiment, the heating coil of the terminal heat exchanger is located in the reheat position, i.e. “downstream” of the cooling coil (from an airflow direction perspective). The reheat process involves simultaneous operation of the cooling and heating coils to provide more precise control of the room air relative humidity. For example, when the discharge air temperature from the terminal heat exchanger 30 that is required to dehumidify the room air is such that may cause overcooling of the room environment, the heating control device 32 may be operated to circulate the heating medium through the heating coil to help attain/maintain a desired air temperature within the room. The terminal heat exchanger 30 may be any suitable type of heat exchanger, (shown for example in FIG. 2 as a vertical unit), and may be disposed at any suitable location within the room 12 to suit a particular application, such as on the floor, on the ceiling, wall-mounted low, wall-mounted high, etc. According to alternative embodiments, the terminal heat exchanger may be any suitable type of heat exchange device and may be installed at any suitable location within the room to provide a desired airflow circulation pattern.

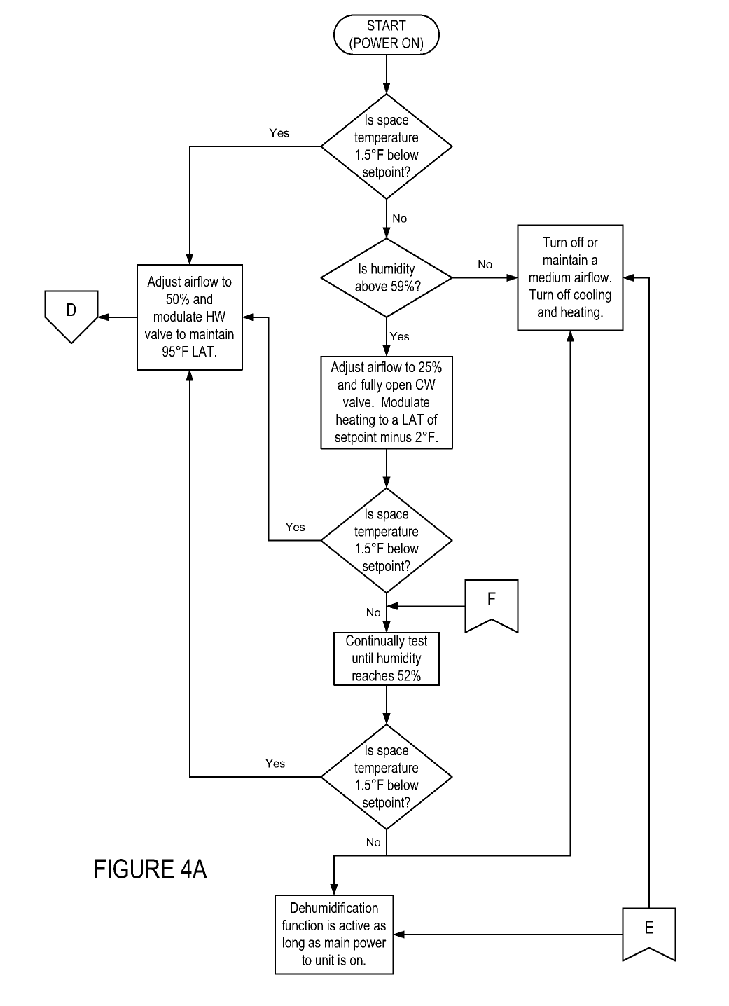

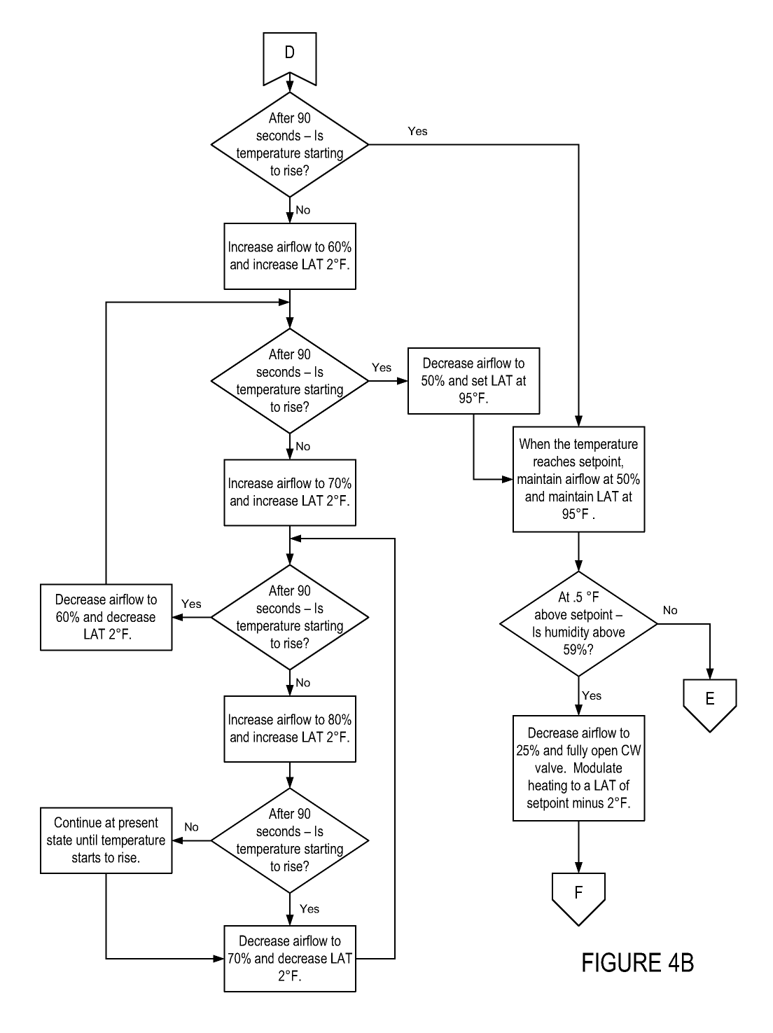

Referring to FIGS. 3A-3B and 4A-4B, and FIGS. 5 and 6, a method for implementing the system 10 for controlling a room environment (in a cooling/dehumidification mode—FIGS. 3A-3B, and a heating/dehumidification mode—FIGS. 4A-4B) is shown according to an exemplary embodiment. The thermostat portion 52 of the environmental control device 50 monitors the room air temperature from temperature sensor 52 and provides the signal representative of temperature 62 to the controller portion 54. When the room air temperature is greater than a desired room air temperature setpoint programmed into the controller portion 54 (i.e. the actual room air temperature is too warm) the system operates in the cooling/dehumidification mode. Similarly, when the room air temperature is less than a desired room air temperature setpoint programmed into the controller portion 54 (i.e. the actual room air temperature is too cool) the system operates in the heating/dehumidification mode.

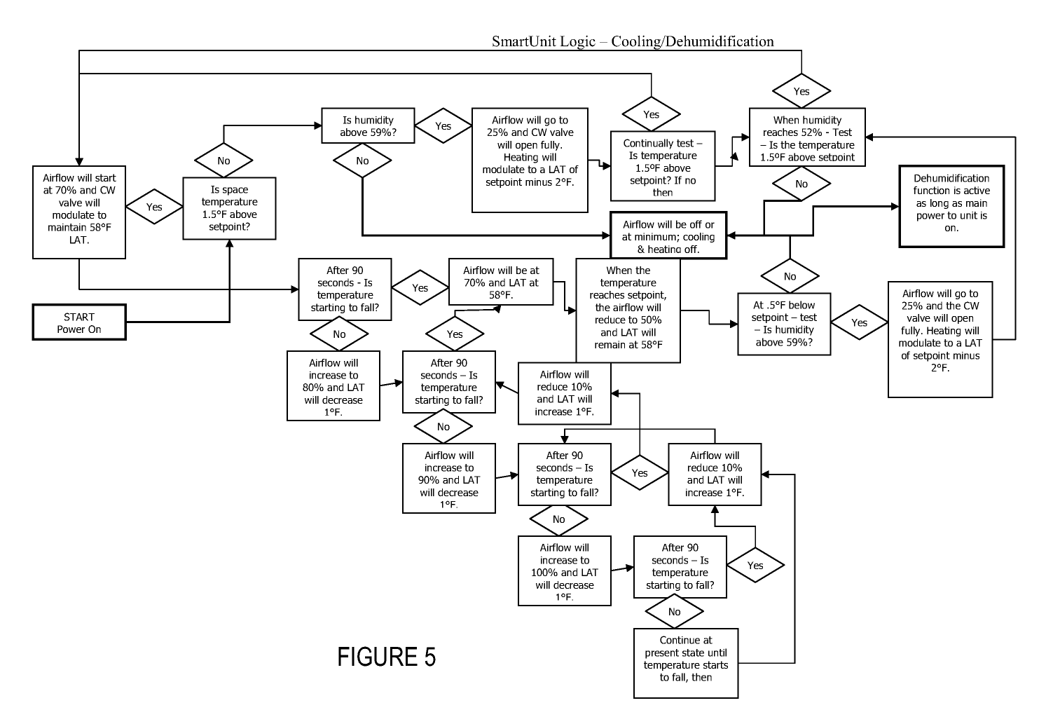

Referring to the method for implementing the system 10 for controlling a room environment in a cooling/dehumidification mode as shown in FIGS. 3A-3B and 5, the method includes the following steps, as may be programmed in the controller portion 54 of the environmental control device 50 for reading the signals received from the thermostat portion 52 and providing output control signals for controlling the room environment.

1. The power to the environmental control device 50 is turned on.

2. The controller portion 54 reads the signal representative of a room air temperature 62 received from the thermostat portion 52 and determines if the room air temperature deviates above a temperature setpoint (e.g. 72° F. or other suitable temperature setpoint corresponding to a desired comfort level within the room 12) by a predetermined temperature variation amount. According to one embodiment, the temperature setpoint is a manually adjustable setpoint provided on the thermostat portion 52 that may be manually set or adjusted by a user (e.g. room occupant, etc.) and the temperature variation amount is approximately 1.5° F. According to an alternative embodiment, the temperature setpoint may be remotely or automatically set, and the predetermined temperature variation amount may be any suitable temperature variation.

3. If the room air temperature does not exceed the temperature setpoint by the temperature variation amount, then the controller portion 54 reads the signal representative of a room air relative humidity 64 received from the thermostat portion 52 and determines if the relative humidity exceeds a desired humidity setting. According to one embodiment, the humidity setting is approximately 59% relative humidity. According to alternative embodiments, the humidity setting is less than approximately 60% relative humidity, and more preferably within a range of approximately 52-59% relative humidity. The applicants believe that a relative humidity within a range of approximately 52-59% is advantageous for a majority of applications because relative humidity above 60% tends to promote formation of growth of undesirable materials such as mold, mildew, etc., while a relative humidity of less than approximately 52% tends to decrease the comfort level corresponding to a typically preferred air temperature within the room 12 (such as, for example, approximately 72° F.).

4. If the room air relative humidity is not above the humidity setting (e.g. 59%), then the controller portion 54 will provide an airflow control signal 76 to the airflow device 36 corresponding to an “off” condition (for no airflow) or a “minimum” condition for maintaining a minimum level of air circulation within the room 12, and the controller portion 54 will continue to monitor and process the room air relative humidity signal 64 received from the thermostat portion 52.

5. Referring back to step 2 of the cooling/dehumidification mode, if the room air temperature does exceed the temperature setpoint by the temperature variation amount, then the controller portion 54 will provide an airflow control signal 76 to the airflow device 36 to start (if the airflow device was off) and to operate for 70% airflow, and a cooling control signal 72 to the cooling control device 34 to modulate to maintain a discharge air temperature at the terminal heat exchanger 30 of approximately 58° F. (however, other discharge air temperatures may be used according to alternative embodiments).

6. The controller portion includes a timing device and after a predetermined time delay (such as approximately 90 seconds or other suitable time delay), will process the signal representative of room air temperature 62 from the thermostat portion 52 to determine if room air temperature is beginning to decrease. If the room air temperature is decreasing, then the controller portion 54 will provide an airflow control signal 76 to maintain the airflow device 36 at 70% airflow and a cooling control signal 72 to modulate the cooling control device 34 for a discharge temperature at the terminal heat exchanger 30 of approximately 58° F. When the room air temperature decreases sufficiently to reach the temperature setpoint, then the controller portion 54 will provide an airflow control signal 76 to reduce the speed of the airflow device 36 for 50% airflow. The controller portion 54 will wait until the room air temperature decreases to 0.5° F. (or other suitable temperature margin) below the temperature setpoint and then process the signal representative of room air relative humidity 64 from the thermostat portion 52 to determine if the room air relative humidity is above the humidity setting. If the room air relative humidity does not exceed the humidity setting, then the controller portion 54 will provide an airflow control signal 76 to the airflow device 36 corresponding to an “off” condition (for no airflow) or a “minimum” condition for maintaining a minimum level of air circulation within the room 12, and the controller portion 54 will continue to monitor and process the room air relative humidity signal 64 received from the thermostat portion 54. If the room air relative humidity does exceed the humidity setting, then the controller portion 54 will provide an airflow control signal 76 to the airflow device 36 to operate for approximately 25% airflow, and will provide a cooling control signal 72 to the cooling control device 34 to open fully (i.e. maximum cooling and dehumidification), and will provide a heating control signal 68 to the heating control device 32 to modulate to maintain a discharge air temperature at the terminal heat exchanger 30 of 2° F. (or other suitable temperature margin) below the temperature setpoint. The controller portion 54 will continue to monitor the signal representative of room air relative humidity 64 and when the room air relative humidity reaches approximately 52%, the controller portion 54 will monitor the signal representative of room air temperature 62 received from the thermostat portion 52. If the room air temperature is less than 1.5° F. above the temperature setpoint, then the controller portion 54 will provide an airflow control signal 76 for “off” or “minimum” speed, and will provide a heating control signal 68 and cooling control signal 72 to close the heating 32 and cooling 34 control devices to terminate heating and cooling operation. If the room air temperature is greater than 1.5° F. above the temperature setpoint, then the controller portion 54 will provide an airflow control signal 76 to the airflow device 36 to operate for 70% airflow and a cooling control signal 72 to the cooling control device 34 to modulate to maintain a discharge air temperature at the terminal heat exchanger 30 of 58° F., as described in step 5.

7. Referring back to step 6, if after the time delay (e.g. 90 seconds) the room air temperature has not begun to decrease, than the controller portion 54 will provide an airflow control signal 76 to operate the airflow device 36 for approximately 80% airflow and provide a cooling control signal 72 to the cooling control device 34 to decrease the discharge air temperature at the terminal heat exchanger 30 by 1° F. (or other suitable amount). If after another suitable time delay (e.g. 90 seconds) the room temperature has begun to decrease, then the controller portion 54 will provide an airflow control signal 76 to the airflow device 36 to decrease to 70% airflow and a cooling control signal 72 to the cooling control device 34 to modulate to maintain a discharge air temperature at the terminal heat exchanger 30 of approximately 58° F., and then continue monitoring as outlined in step 6. If after the 90 second time delay the room temperature has not begun to decrease, then the controller portion 54 will provide an airflow control signal 76 to the airflow device 36 to increase to 90% airflow and a cooling control signal 72 to decrease the discharge air temperature at the terminal heat exchanger 30 by an additional 1° F. (or other suitable amount). In a similar manner, the controller portion 54 will continue to monitor the room air temperature after suitable time delays to determine if the room air temperature is decreasing. If the room air temperature is not decreasing, the controller portion 54 will continue to provide control signals 76, 72 to the airflow device 36 to increase airflow and to modulate the cooling control device 34 to decrease the discharge air temperature at the terminal heat exchanger 30 in incremental amounts until the room air temperature begins to decrease. When the controller portion 54 determines that the room air temperature is decreasing, the controller portion 54 will provide control signals 76, 72 to the airflow device to decrease air flow and to modulate the cooling control device 34 to increase the discharge air temperature at the terminal heat exchanger 30 in incremental amounts until the airflow reaches 70% and the discharge air temperature at the terminal heat exchanger 30 reaches 58° F., and then continue to monitor until the temperature setpoint is reached, as previously described in step 6.

8. Referring back to step 4, if the room air relative humidity is above the humidity setting (e.g. 59%), then the controller portion 54 will provide an airflow control signal 76 to the airflow device 36 to operate for approximately 25% airflow, and will provide a cooling control signal 72 to the cooling control device 34 to open fully (i.e. maximum cooling and dehumidification), and will provide a heating control signal 68 to the heating control device 32 to modulate to maintain a discharge air temperature at the terminal heat exchanger 30 of 2° F. (or other suitable temperature margin) below the temperature setpoint. The controller portion 54 will continue to monitor the signal representative of room air relative humidity 64 and when the room air relative humidity reaches approximately 52%, the controller portion 54 will monitor the signal representative of room air temperature 62 received from the thermostat portion 52. If the room air temperature is less than 1.5° F. above the temperature setpoint, then the controller portion 54 will provide an airflow control signal 76 for “off” or “minimum” speed, and will provide a heating control signal 68 and cooling control signal 72 to close the heating and cooling control devices 32, 34 to terminate heating and cooling operation. If the room air temperature is greater than 1.5° F. above the temperature setpoint, then the controller portion 54 will provide an airflow control signal 76 to the airflow device 36 to operate for 70% airflow and a cooling control signal 72 to the cooling control device 34 to modulate to maintain a discharge air temperature at the terminal heat exchanger 30 of 58° F., as described in step 5.

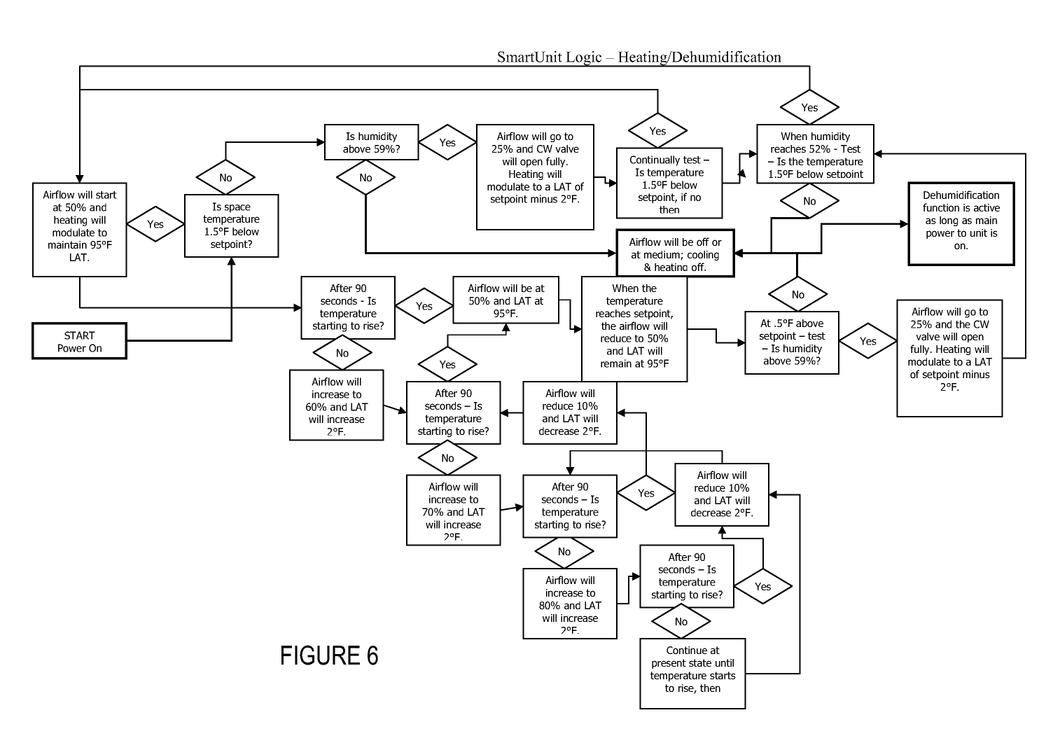

Referring now to the method for implementing the system 10 for controlling a room environment in a heating/dehumidification mode as shown in FIGS. 4A-4B and 6, the method includes the following steps, as may be programmed in the controller portion 54 of the environmental control device 50 for reading the signals received from the thermostat portion 52 and providing output control signals for controlling the room environment.

1. The power to the environmental control device 50 is turned on.

2. The controller portion 54 reads the signal representative of a room air temperature 62 received from the thermostat portion 52 and determines if the room air temperature deviates below a temperature setpoint (e.g. 72° F. or other suitable temperature setpoint corresponding to a desired comfort level within the room) by a predetermined temperature variation amount. According to one embodiment, the temperature setpoint is a manually adjustable setpoint provided on the thermostat portion that may be manually set or adjusted by a user (e.g. room occupant, etc.) and the temperature variation amount is approximately 1.5° F. According to an alternative embodiment, the temperature setpoint may be remotely or automatically set, and the predetermined temperature variation amount may be any suitable temperature variation.

3. If the room air temperature is not below the temperature setpoint by the temperature variation amount, then the controller portion 54 reads the signal representative of a room air relative humidity 64 received from the thermostat portion 52 and determines if the relative humidity exceeds a desired humidity setting. According to one embodiment, the humidity setting is approximately 59% relative humidity. According to alternative embodiments, the humidity setting is less than approximately 60% relative humidity, and more preferably within a range of approximately 52-59% relative humidity.

4. If the room air relative humidity is not above the humidity setting (e.g. 59%), then the controller portion 54 will provide an airflow control signal 76 to the airflow device 36 corresponding to an “off” condition (for no airflow) or a “minimum” condition for maintaining a minimum level of air circulation within the room 12, and the controller portion 54 will continue to monitor and process the room air relative humidity signal received from the thermostat portion 52.

5. Referring back to step 2 of the heating/dehumidification mode, if the room air temperature is below the temperature setpoint by the temperature variation amount (or more), then the controller portion 54 will provide an airflow control signal 76 to the airflow device 36 to start (if the airflow device was off) and to operate for 50% airflow, and a heating control signal 68 to the heating control device 32 to modulate to maintain a discharge air temperature at the terminal heat exchanger 30 of approximately 95° F. (however, other discharge air temperatures may be used according to alternative embodiments). The applicants believe that discharge air temperatures above 95° F. tend to promote stratification of the warm air discharged into the room environment and does not promote a desired mixing of the room air, while discharge air temperatures of approximately 95° F. or lower tend to reduce stratification and promote mixing of the air in the room environment.

6. The controller portion 54 includes a timing device and after a predetermined time delay (such as approximately 90 seconds or other suitable time delay), will process the signal representative of room air temperature 62 from the thermostat portion 52 to determine if room air temperature is beginning to increase (e.g. rise). If the room air temperature is increasing, then the controller portion 54 will provide an airflow control signal 76 to maintain the airflow at 50% and a heating control signal 68 to modulate the heating control device 32 to maintain a discharge temperature at the terminal heat exchanger 30 of approximately 95° F. When the room air temperature increases sufficiently to reach the temperature setpoint, then the controller portion 54 will provide an airflow control signal 76 to maintain the speed of the airflow device 36 for 50% airflow. The controller portion 54 will wait until the room air temperature increases to 0.5° F. (or other suitable temperature margin) above the temperature setpoint and then process the signal representative of room air relative humidity 64 from the thermostat portion 52 to determine if the room air relative humidity is above the humidity setting. If the room air relative humidity does not exceed the humidity setting, then the controller portion 54 will provide an airflow control signal 76 to the airflow device 36 corresponding to an “off” condition (for no airflow) or a “minimum” condition for maintaining a minimum level of air circulation within the room 12, and the controller portion 54 will continue to monitor and process the room air relative humidity signal 64 received from the thermostat portion 52. If the room air relative humidity does exceed the humidity setting, then the controller portion 54 will provide an airflow control signal 76 to the airflow device 36 to operate for approximately 25% airflow, and will provide a cooling control signal 72 to the cooling control device 34 to open fully (i.e. maximum dehumidification), and will provide a heating control signal 68 to the heating control device 32 to modulate to maintain a discharge air temperature at the terminal heat exchanger 30 of 2° F. (or other suitable temperature margin) below the temperature setpoint. The controller portion 54 will continue to monitor the signal representative of room air relative humidity 64 and when the room air relative humidity reaches approximately 52%, the controller portion 54 will monitor the signal representative of room air temperature 62 received from the thermostat portion 52. If the room air temperature is less than 1.5° F. below the temperature setpoint, then the controller portion 54 will provide an airflow control signal 76 for “off” or “minimum” speed, and will provide a heating control signal 68 and cooling control signal 72 to close the heating and cooling control devices 32, 34 to terminate heating and dehumidification operation. If the room air temperature is more than 1.5° F. below the temperature setpoint, then the controller portion 54 will provide an airflow control signal 76 to the airflow device 36 to operate for 50% airflow and a heating control signal 68 to the heating control device 32 to modulate to maintain a discharge air temperature at the terminal heat exchanger 30 of 95° F., as described in step 5.

7. Referring back to step 6, if after the time delay (e.g. 90 seconds) the room air temperature has not begun to increase, than the controller portion 54 will provide an airflow control signal 76 to operate the airflow device 36 for approximately 60% airflow and provide a heating control signal 68 to the heating control device 32 to increase the discharge air temperature at the terminal heat exchanger 30 by 2° F. (or other suitable amount). If after another suitable time delay (e.g. 90 seconds) the room temperature has begun to increase, then the controller portion 54 will provide an airflow control signal 76 to the airflow device 36 to decrease to 50% airflow and a heating control signal 68 to the heating control device 32 to modulate to maintain a discharge air temperature at the terminal heat exchanger 30 of approximately 95° F., and then continue monitoring as outlined in step 6. If after the 90 second time delay the room temperature has not begun to increase, then the controller portion 54 will provide an airflow control signal 76 to the airflow device 36 to increase to 70% airflow and a heating control signal 68 to increase the discharge air temperature at the terminal heat exchanger 30 by an additional 2° F. (or other suitable amount). In a similar manner, the controller portion 54 will continue to monitor the room air temperature after suitable time delays to determine if the room air temperature is increasing. If the room air temperature is not increasing, the controller portion 54 will continue to provide control signals 76, 68 to the airflow device 36 to increase airflow and to modulate the heating control device 32 to increase the discharge air temperature at the terminal heat exchanger 30 in incremental amounts until the room air temperature begins to increase. When the controller portion 54 determines that the room air temperature is increasing, the controller portion 54 will provide control signals 76, 68 to the airflow device 36 to decrease air flow and to modulate the heating control device 32 to decrease the discharge air temperature at the terminal heat exchanger 30 in incremental amounts until the airflow reaches 50% and the discharge air temperature at the terminal heat exchanger 30 reaches 95° F., and then continue to monitor until the temperature setpoint is reached, as previously described in step 6.

8. Referring back to step 4, if the room air relative humidity is above the humidity setting (e.g. 59%), then the controller portion 54 will provide an airflow control signal 76 to the airflow device 36 to operate for approximately 25% airflow, and will provide a cooling control signal 72 to the cooling control device 34 to open fully (i.e. maximum dehumidification), and will provide a heating control signal 68 to the heating control device 32 to modulate to maintain a discharge air temperature at the terminal heat exchanger 30 of 2° F. (or other suitable temperature margin) below the temperature setpoint. The controller portion 54 will continue to monitor the signal representative of room air relative humidity 64 and when the room air relative humidity reaches approximately 52%, the controller portion 54 will monitor the signal representative of room air temperature 62 received from the thermostat portion 52. If the room air temperature is less than 1.5° F. below the temperature setpoint, then the controller portion 54 will provide an airflow control signal 76 for “off” or “minimum” speed, and will provide a heating control signal 68 and cooling control signal 72 to close the heating and cooling control devices 32, 34 to terminate heating and cooling operation. If the room air temperature is greater than 1.5° F. below the temperature setpoint, then the controller portion 54 will provide an airflow control signal 76 to the airflow device 36 to operate for 50% airflow and a heating control signal 68 to the heating control device 32 to modulate to maintain a discharge air temperature at the terminal heat exchanger of 95° F., as described in step 5.

According to any exemplary embodiment, a system and method are provided for controlling a room environment that optimizes both the temperature and humidity of the air space within a room, regardless of the type and size of the terminal heat exchanger and regardless of variations in the temperature, flow rate, or other parameters of the cooling/heating supply water received from the central heating and cooling supply system; and that improves the efficiency of operation of the terminal heat exchanger within the room, and the efficiency of operation of the central heating and cooling system supply for the facility. The system includes an environmental control device having a thermostat portion operable to obtain or receive signals representative of room air temperature and room air humidity, and to transmit these signals to a controller portion of the device. The controller portion receives the signals representative of the room air temperature, room air relative humidity, and a temperature of discharge air leaving the terminal heat exchanger, and processes the signals according to a method (implemented according to a set of instructions or algorithms programmed in the controller portion) to modulate heating and cooling control devices and an airflow device to obtain/maintain a desired environment within the room (e.g. relative humidity within a range of approximately 52-59% and air temperature within a range of approximately 1.5° F. of a desired temperature setpoint). The method outlines a specific sequence of steps and instructions for controlling the components of the terminal heat exchanger for optimum airflow and heat transfer to control the room environment regardless of the specific type of terminal heat exchanger and regardless of the specific parameters of the heating and cooling medium provided by the central facility heating and cooling supply.

It is important to note that the construction and arrangement of the elements and embodiments of the system and method for controlling a room environment provided herein are illustrative only. Although only a few exemplary embodiments of the present invention have been described in detail in this disclosure, those skilled in the art who review this disclosure will readily appreciate that many modifications are possible in these embodiments (such as variations in features such as types and locations of terminal heat exchangers, types of heating and cooling control devices, types of airflow devices, types and location of the thermostat and/or controller portions of the environmental control device, and their associated sensors; variations in sizes, structures, shapes, dimensions and proportions of the components of the system, use of materials, types of rooms and facilities within which the system is applied, etc.) without materially departing from the novel teachings and advantages of the invention. According to other alternative embodiments, the heating and cooling control devices may be other type of control devices for modulating a source of heating or cooling to the terminal heat exchanger, and the terminal heat exchanger may be of type specified for use in any commercial, institutional or residential facility. Further, it is readily apparent that variations of the system and its components and elements may be provided in a wide variety of types, shapes, sizes and performance characteristics, or provided in locations external or partially external to the room. Accordingly, all such modifications are intended to be within the scope of the invention.

The order or sequence of any process or method steps may be varied or re-sequenced according to alternative embodiments. In the claims, any means-plus-function clause is intended to cover the structures described herein as performing the recited function and not only structural equivalents but also equivalent structures. Other substitutions, modifications, changes and omissions may be made in the design, operating configuration and arrangement of the preferred and other exemplary embodiments without departing from the spirit of the inventions as expressed in the appended claims.

What is claimed is:

1. A system for controlling an environment in a room of a facility, comprising:
a terminal heat exchanger disposed in the room and operable to transfer heat to and from the environment in the room;
an environmental control device operable to provide control signals to the terminal heat exchanger in response to a signal representative of a room air temperature and a signal representative of a room air relative humidity and a signal representative of a discharge temperature of an airflow leaving the terminal heat exchanger;
the environmental control device operable to execute a preprogrammed algorithm that:
(a) determines if the room air temperature is greater than, or less than, a temperature setpoint by a predetermined amount;
(b) determines if the room air relative humidity is greater than an upper relative humidity setpoint; and
(c) transmits the control signals to the terminal heat exchanger to modulate the airflow through the terminal heat exchanger and to modulate the discharge temperature of the airflow leaving the terminal heat exchanger until a predetermined room air temperature and room air relative humidity are obtained.

2. The system of claim 1 wherein the environmental control device comprises a thermostat portion and a controller portion, the thermostat portion configured to send the signals representative of the room air temperature and the room air relative humidity to the controller portion.

3. The system of claim 2 wherein the terminal heat exchanger further comprises a heating control device configured to modulate a flow of a heating medium received from a central heating supply at the facility, and a cooling control device configured to modulate a flow of a cooling medium received from a central cooling supply at the facility, and an airflow device configured to modulate the airflow through the terminal heat exchanger.

4. The system of claim 3 wherein the heating control device and the cooling control device each comprise a characterized ball valve.

5. The system of claim 3 wherein the airflow device further comprises a fan and a motor, and wherein the motor comprises an electronically commutated motor.

6. The system of claim 3 wherein the control signals comprise a heating control signal operable to modulate the heating control device, and a cooling control signal operable to modulate the cooling control device, and an airflow control signal operable to modulate the airflow device.

7. The system of claim 6 wherein the preprogrammed algorithm includes a cooling/dehumidification mode and a heating/dehumidification mode.

8. The system of claim 7 wherein when the room air temperature exceeds the temperature setpoint by a first predetermined margin, the environmental control device operates in the cooling/dehumidification mode and the airflow control signal modulates the airflow device for approximately 70% airflow, and the cooling control signal modulates the cooling control device so that the discharge temperature of the airflow is approximately 58° F.

9. The system of claim 8 wherein the first predetermined margin is approximately 1.5° F.

10. The system of claim 8 wherein the airflow control signal will incrementally modulate the airflow device to increase the airflow and the cooling control signal will incrementally modulate the cooling control device to decrease the discharge air temperature until the controller portion determines that the room air temperature is decreasing.

11. The system of 10 wherein the airflow control signal will modulate the airflow device to decrease the airflow and the cooling control signal will modulate the cooling control device to increase the discharge air temperature when the controller portion determines that the room air temperature is within a second predetermined margin below the temperature setpoint.

12. The system of claim 11 wherein the second predetermined margin is approximately 0.5° F.

13. The system of claim 11 wherein when the controller portion determines that the room air humidity exceeds the upper relative humidity setpoint, the airflow control signal will modulate the airflow device to further decrease the airflow and the cooling control signal will fully open the cooling control device dehumidify the environment and the heating control signal will modulate the heating control device so that the discharge air temperature is below the temperature setpoint by a third predetermined margin.

14. The system of claim 13 wherein the third predetermined margin is approximately 2° F.

15. The system of claim 13 wherein when the controller portion determines that the room air humidity reaches a lower relative humidity setpoint, and the room air temperature does not exceed the first predetermined margin above the setpoint, the airflow control signal will modulate the airflow device to further decrease or stop the airflow and the cooling control signal will close the cooling control device and the heating control signal will close the heating control device.

16. The system of claim 13 wherein when the controller portion determines that the room air humidity reaches a lower relative humidity setpoint, and the room air temperature exceeds the first predetermined margin above the setpoint, the airflow control signal will modulate the airflow device for approximately 70% airflow and the cooling control signal will modulate the cooling control device so that the discharge temperature of the airflow is approximately 58° F.

17. The system of claim 7 wherein when the room air temperature is less than the first predetermined margin above the temperature setpoint and the room air relative humidity exceeds the upper relative humidity setpoint, the environmental control device operates in the cooling/dehumidification mode and the airflow control signal modulates the airflow device for approximately 25% airflow, and the cooling control signal fully opens the cooling control device to dehumidify the environment, and the heating control signal modulates the heating control device so that the discharge air temperature is below the temperature setpoint by the third predetermined margin.

18. A method for controlling a temperature and a relative humidity of an environment in a room of a facility during a cooling/dehumidification mode, the room having a terminal heat exchanger that receives a heating medium and a cooling medium from a supply source in the facility, the terminal heat exchanger including a heating control device and a cooling control device and an airflow device, the method comprising:
providing an environmental control device operable to provide control signals to the terminal heat exchanger in response to a signal representative of a room air temperature and a signal representative of a room air relative humidity and a signal representative of a discharge temperature of an airflow leaving the terminal heat exchanger; and
programming the environmental control device to accomplish the following operations:
(a) determining if the room air temperature exceeds a temperature setpoint by a first predetermined margin,
(b) sending an airflow control signal to modulate the airflow device for a first airflow, and sending a cooling control signal to modulate the cooling control device so that a discharge temperature of the first airflow is first temperature when the room air temperature exceeds the temperature setpoint by the first predetermined margin;
(c) modulating the airflow device to incrementally increase the airflow and modulating the cooling control device to incrementally decrease the discharge air temperature until the room air temperature is decreasing;
(d) modulating the airflow device to decrease the airflow and modulating the cooling control device to increase the discharge air temperature, when the room air temperature is within a second predetermined margin below the temperature setpoint;
(e) modulating the airflow device to further decrease the airflow and fully opening the cooling control device to dehumidify the environment and modulating the heating control device so that the discharge air temperature is below the temperature setpoint by a third predetermined margin, when the room air humidity exceeds an upper relative humidity setpoint;
(f) modulating the airflow device to further decrease or stop the airflow and closing the cooling control device and the heating control device, when the room air humidity reaches a lower relative humidity setpoint, and the room air temperature does not exceed the first predetermined margin above the temperature setpoint;
(g) modulating the airflow device for the first airflow and modulating the cooling control device so that the discharge temperature of the airflow is the first temperature, when the room air humidity reaches a lower relative humidity setpoint, and the room air temperature exceeds the first predetermined margin above the temperature setpoint;
(h) modulating the airflow device for a second airflow and fully opening the cooling control device to dehumidify the environment, and modulating the heating control device so that the discharge air temperature is below the temperature setpoint by the third predetermined margin, when the room air temperature is less than the first predetermined margin above the temperature setpoint and the room air relative humidity exceeds the upper relative humidity setpoint.

19. The method of claim 18, wherein the first predetermined margin is approximately 1.5° F., and the second predetermined margin is approximately 0.5° F., and the third predetermined margin is approximately 2.0° F., and the first airflow is approximately 70%, and the second airflow is approximately 25%, and the first temperature is approximately 58° F.

20. A method for controlling a temperature and a relative humidity of an environment in a room of a facility during a heating/dehumidification mode, the room having a terminal heat exchanger that receives a heating medium and a cooling medium from a supply source in the facility, the terminal heat exchanger including a heating control device and a cooling control device and an airflow device, the method comprising:
providing an environmental control device operable to provide control signals to the terminal heat exchanger in response to a signal representative of a room air temperature and a signal representative of a room air relative humidity and a signal representative of a discharge temperature of an airflow leaving the terminal heat exchanger; and
programming the environmental control device to accomplish the following operations:
(a) determining if the room air temperature is less than a temperature setpoint by a first predetermined margin,
(b) sending an airflow control signal to modulate the airflow device for approximately a first airflow, and sending a heating control signal to modulate the heating control device so that a discharge temperature of the first airflow is a first temperature when the room air temperature is less than the temperature setpoint by the first predetermined margin;
(c) modulating the airflow device to incrementally increase the airflow and modulating the heating control device to incrementally increase the discharge air temperature until the room air temperature is increasing;
(d) modulating the airflow device to decrease the airflow and modulating the heating control device to decrease the discharge air temperature, when the room air temperature is within a second predetermined margin above the temperature setpoint;
(e) modulating the airflow device to further decrease the airflow and fully opening the cooling control device to dehumidify the environment and modulating the heating control device so that the discharge air temperature is below the temperature setpoint by a third predetermined margin, when the room air humidity exceeds an upper relative humidity setpoint;
(f) modulating the airflow device to further decrease or stop the airflow and closing the cooling control device and the heating control device, when the room air humidity reaches a lower relative humidity setpoint, and the room air temperature is not less than the first predetermined margin below the temperature setpoint;
(g) modulating the airflow device for approximately 50% airflow and modulating the heating control device so that the discharge temperature of the airflow is approximately 95° F., when the room air humidity reaches a lower relative humidity setpoint, and the room air temperature is less than the first predetermined margin below the temperature setpoint; and
(h) modulating the airflow device for a second airflow and fully opening the cooling control device to dehumidify the environment, and modulating the heating control device so that the discharge air temperature is below the temperature setpoint by the third predetermined margin, when the room air temperature exceeds the first predetermined margin below the temperature setpoint and the room air relative humidity exceeds the upper relative humidity setpoint.

21. The method of claim 20, wherein the first predetermined margin is approximately 1.5° F., and the second predetermined margin is approximately 0.5° F., and the third predetermined margin is approximately 2.0° F., and the first airflow is approximately 50%, and the second airflow is approximately 25%, and the first temperature is approximately 95° F.
